(19) United States
(12) Patent Application Publication
(10) Pub. No.: US 2015/0118953 A1
(43) Pub. Date: Apr. 30, 2015

(54) Multicast of audio/video streams to authorized recipients over a private wireless network

(71) Applicant: Shahram Davari, Los Altos, CA (US)

(72) Inventor: Shahram Davari, Los Altos, CA (US)

(21) Appl. No.: 13/998,418

(22) Filed: Oct. 31, 2013

(51) Int. Cl. H04W 4/06; H04W 4/00; G06F 3/16; H04W 12/06

(52) U.S. Cl. CPC H04W 4/06; H04W 12/06; H04W 4/008; G06F 3/165
USPC 455/3.06

(57) ABSTRACT

This invention describes a system that can reuse existing ubiquitous wireless networks such as WiFi or Bluetooth to transmit audio/video channels to a group of recipients, which can listen/watch to the live transmitted audio/video streams using their own smart phones, tablets or PDAs. The system is confined to authorized recipients within a private wireless network and the recipients may see the playlist and library and request any audio/video to be added to the playlist or moved up the play list.

### BACKGROUND OF THE INVENTION

There is a new trend in the music industry called Silent Party or Silent Disco, where each guest is given a special wireless headphone and the DJ transmits the music using a special wireless transmitter. However the headphone and wireless transmitters use special radio technology and special hardware and are therefore not readily available to mass market.

This invention uses generally available wireless technology, such as WiFi or Bluetooth and smartphones such as iPhone or Android phones to achieve the same function, and eliminates the need for special headphones and special wireless transmitter. All that is required is new application software on the smart phone and new application software on the computer or Tablet for the DJ, and no special hardware is required.

### SUMMARY OF THE INVENTION

This invention uses publicly available wireless technology such as WiFi or Bluetooth to multicast/broadcast AudioNideo streams to a group of people who are authorized to receive those streams. It does not require any special hardware, and can re-use existing smart phones, PDA, Tablet and computers to achieve this function. One of the main applications of this invention is to enable silent parties, where a DJ transmits one or more music channels over the WiFi and the guests receive those music channels via their smart phones and listen to it via their own headphones that are connected to their smart phone.

### BRIEF DESCRIPTION OF THE DRAWINGS

FIG. 1 is a flow diagram showing how a DJ creates one or more wireless DJ Channels

FIG. 2 is a flow diagram showing how a guest/user joins one or more wireless DJ Channels

FIG. 3 is a flow diagram showing how a guest/user selects a preferred song from a wireless DJ Playlist.

FIG. 4 is a flow diagram showing how a guest/user selects a preferred song from a wireless DJ library to be added to any playlist.

FIG. 5 is a network diagram showing how a DJ sends audio/video to a group of users, where the users can use their smart device to listen/watch.

### DETAILED DESCRIPTION OF THE PREFERRED EMBODIMENTS

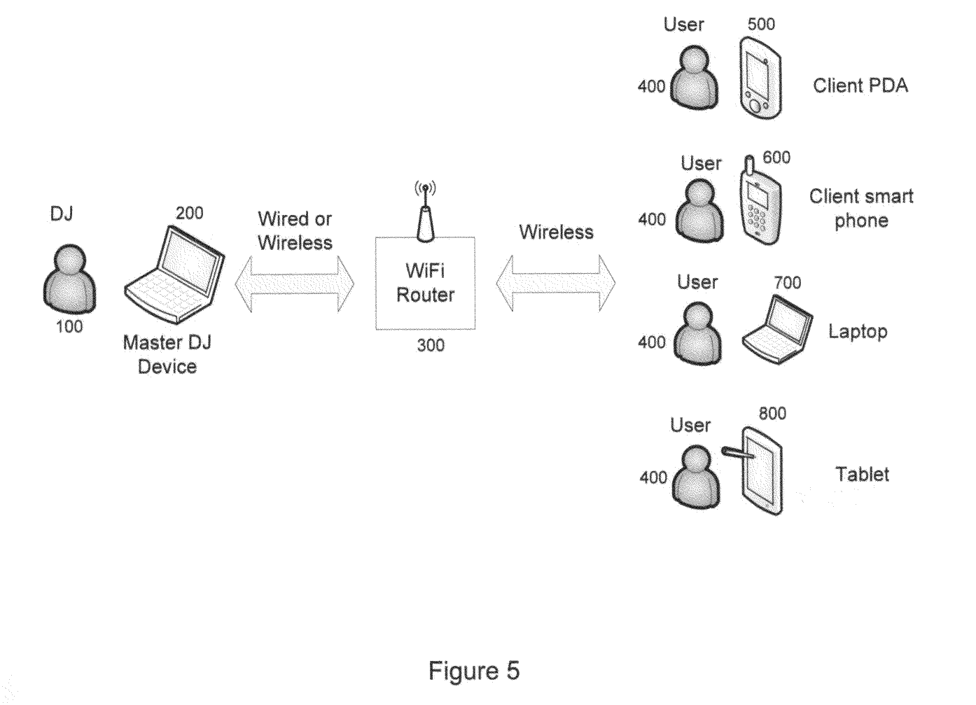

As shown in FIG. 5, one embodiment of the system described by this invention is used for silent parties, where the DJ (100) transmits one or more playlist of songs over one or more Multicast groups to a WiFi Router (300) using Master DJ device (200). Each Multicast group can be a DJ music channel. Each user (400) then joins the WiFi network by connecting to WiFi router (300) and can then join one or more Multicast groups within that WiFi network and can listen to any music being played by DJ (100) over those WiFi multicast groups using PDA (500), Smart phone (600), Laptop (700) or Tablet (800).

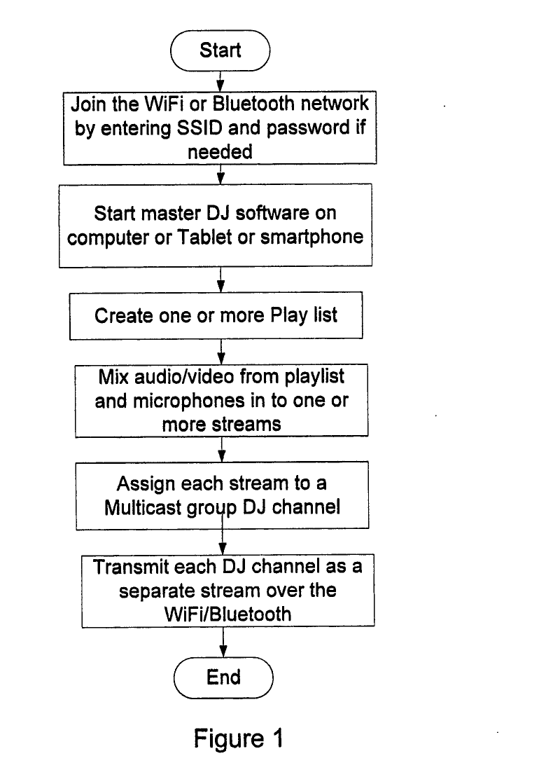

As shown in FIG. 1, a DJ sets up one or more Master DJ Channels on the WiFi or Bluetooth network. First the DJ joins the available WiFi or Bluetooth network via his Laptop, Tablet, Smartphone or other smart devices. The process of joining the WiFi or Bluetooth network may require providing WiFi Authentication requests such as SSID and password. Then the DJ starts the Master DJ software. The Master DJ Software allows the DJ to create one or more DJ Channels by creating one or more Multicast groups over the WiFi or Bluetooth network. The actual physical transmission of the DJ Channel over the Multicast group may use Multicast capabilities of the WiFi or Bluetooth network or may be in the form of creating unicast streams for each guest/user. The DJ then assigns an Authentication credential such as a password or a QR code to each Multicast group and then starts transmitting AudioNideo stream to each Multicast group.

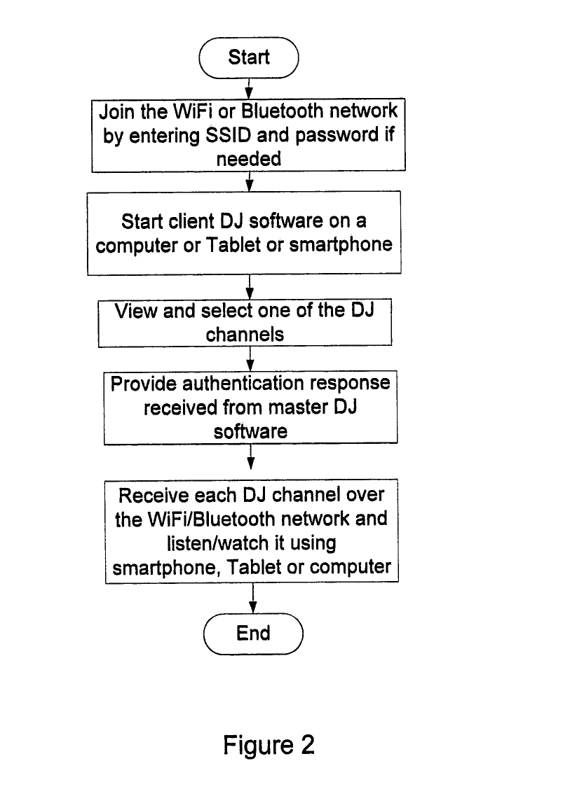

As shown in FIG. 2 a guest/user joins a DJ channel. The user joins the available WiFi or Bluetooth network via his Laptop, Tablet, Smartphone or other smart devices. The process of joining the WiFi or Bluetooth network may require providing WiFi Authentication requests such as SSID and password. Then the user starts the client DJ software. The client DJ software allows the user to see available DJ Channels and request to join any of those DJ Channels. The Master DJ software then asks the user for Authentication, and the user provides Authentication in the form of a password or by scanning or taking picture of a QR code on his smart device. After the user is authenticated the user can listen to any DJ Channel that he/she has joined using his/her own headphone attached to his/her smart device.

The DJ Channels are only accessible to the users inside the WiFi network and only to those that are authenticated by Master DJ software. This security feature prevents unauthorized listening to the DJ's audio/video streams.

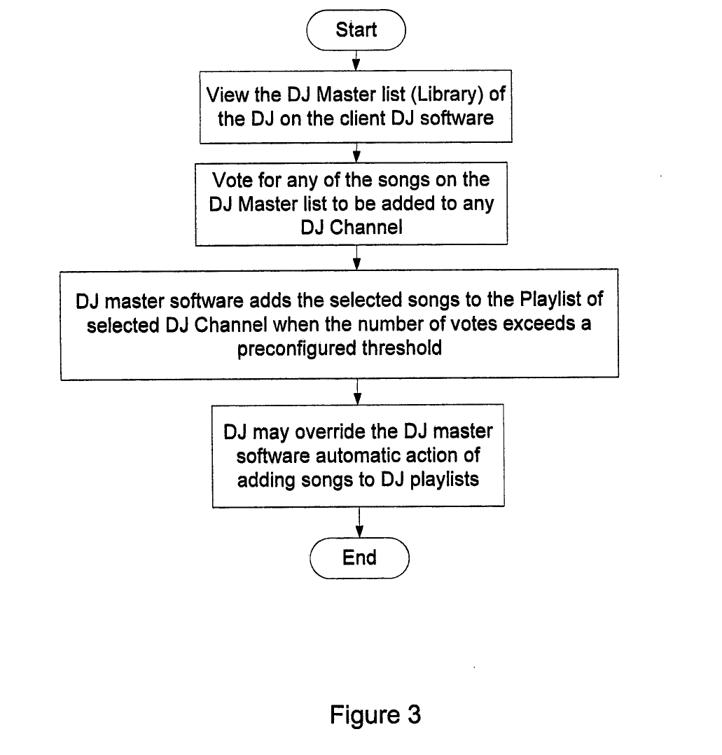

As shown in FIG. 3, any authorized user can also see the playlist on any of the DJ Channels on the client DJ application software on his smart device and vote for any of the songs on the playlist. The Master DJ software can then prioritize the songs based on their popularity, meaning the songs with most vote gets played earlier or more often than the songs with less votes. The DJ himself may override the user votes if required.

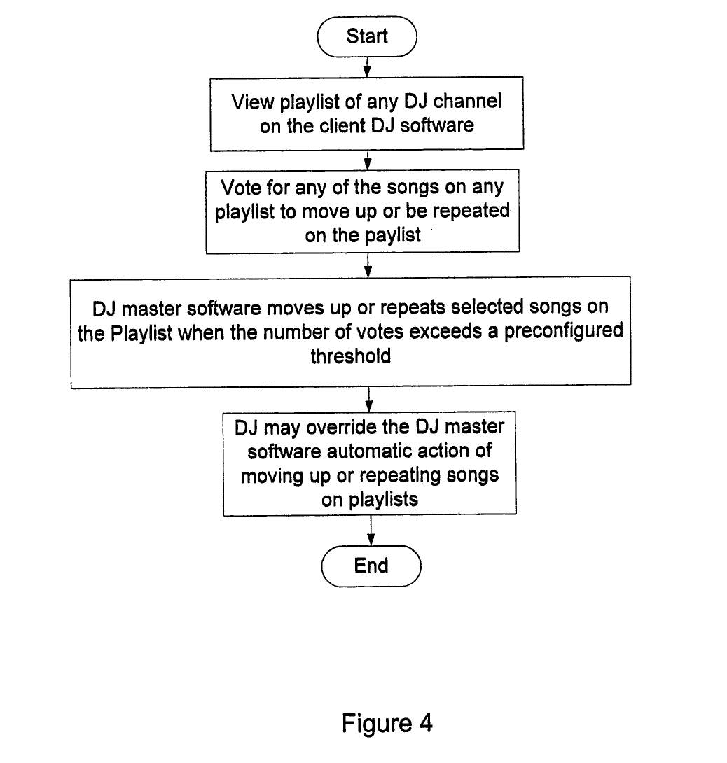

As shown in FIG. 4, any authorized user can also see the Master list in the DJ's Library on the clinet DJ application software on his smart device and vote for any of the songs on the Master Library to be added to any of the DJ channels. The Master DJ software can then add the songs based on a configurable minimum number of votes to any of the DJ play lists. The DJ himself may override the user votes if required.

The Master DJ software is also able to mix audio/video streams including any live microphone and play them in to the DJ channels. Each DJ channel is then transmitted to a Multicast group associated with that DJ channel. User can easily select which DJ channel to listen to on his smart device via the client DJ software. There are many ways to simplify the DJ channel selection. In one embodiment the user presses a pre-configured button on his smart device one or more times or via a pre-configured pattern to select the DJ channel. For example pressing it once can select DJ Channel 1 and pressing it twice can select DJ Channel 2.

In one embedment of this invention a user may send a message to the DJ via the client DJ software, such as asking DJ to announce a birthday and the Master DJ software can receive and the DJ may respond to the request using master DJ software.

1. A system for securely transmitting one or more audio or video streams over a private wireless network to one or more clients, said system comprising:
a master device; and
a master transmission module;
a master authorization module;
one or more client devices;
one or more client reception modules;
one or more client authorization module;
one or more headphone;
wherein said master transmission module resides as software within said master device and transmits said one or more audio or video streams over said private wireless network to said one or more client reception modules installed as software on said one or more client devices;
wherein said one or more clients can listen or watch said one or more audio or video streams using said one or more headphones attached to said one or more client devices.

2. A system as in claim 1, wherein said one or more clients can request to subscribe to said one or more audio or video streams, using said one or more client authorization module installed as software in said one or more client devices.

3. A system as in claim 2, wherein said master authorization module manages the authentication of said one or more clients' requests received from said one or more client authorization modules.

4. A system as in claim 1, wherein said private wireless network is a WiFi or Bluetooth network.

5. A system as in claim 1, wherein said master device is a computer, laptop, tablet, smart phone, PDA or any other smart device.

6. A system as in claim 1, wherein said one or more client devices are computer, laptop, tablet, smart phone, PDA or any other smart device.

7. A system as in claim 1, wherein said master device is used by a music Disc Jockey (DJ) to transmit music wirelessly to said one or more clients for the purpose of enabling a silent disco, where there is no ambient music and said one or more clients listen to the DJ music only via said one or more headphones attached to said one or more client devices.

8. A system as in claim 1, wherein said master authorization module accepts password or QR code or any other form of authorization to allow said one or more clients to receive said or more audio or video streams.

9. A system as in claim 1, wherein said one or more clients can select any of said one or more audio or video streams to listen or watch using said one or more client reception modules.

10. A system as in claim 1, wherein said master transmission module, can mix one or more audio or video streams before transmitting them over said private wireless network.

11. A system as in claim 10, wherein said master transmission module, can mix one or more live microphones with said one or more audio or video streams before transmitting them over said private wireless network.

12. A system for requesting songs from a Disc Jockey (DJ), over a private wireless network, said system comprising:
a master device; and
a master module;
one or more client devices;
one or more client modules;
a music library;
one or more playlists;
wherein said master module resides as software within said master device and said one or more client modules resides as software within said one or more client devices.

13. A system as in claim 12, wherein one or more clients can request a first song from said music library to be added to any of said one or more playlists.

14. A system as in claim 13, wherein said requested first song is added to any of said one or more playlists based on the number of said requests being more than a pre-configured threshold.

15. A system as in claim 13, wherein said DJ can override said request for said first song to be added to said one or more playlists.

16. A system as in claim 12, wherein one or more clients can request a second song from said one or more playlists to be played earlier or more often.

17. A system as in claim 16, wherein said second song moves higher in said one or more playlists or is played more often based on the number of said requests for said second song.

18. A system as in claim 16, wherein said DJ can override said request for said second song to be to be played earlier or more often on said one or more playlists.

19. A system as in claim 1, wherein said one or more clients can choose one of said one or more audio or video streams by pressing one or multiple times any button on said one or more client devices.

20. A system as in claim 1, wherein said one or more clients send message to said DJ via said one or more client modules and said DJ can respond to said message via said master module.
